(19) United States
(12) Patent Application Publication
(10) Pub. No.: US 2025/0152982 A1
(43) Pub. Date: May 15, 2025

(54) FIREFIGHTING AGENT STORED IN BATTERIES

(71) Applicant: Tyco Fire Products LP, Cranston, RI (US)

(72) Inventors: Sean S. Troutt, Stephenson, MI (US); Blake Bomann, Greenville, WI (US); Ben Markovitz, Howard, WI (US); David Strobel, Marinette, WI (US)

(73) Assignee: Tyco Fire Products LP, Cranston, RI (US)

(21) Appl. No.: 18/840,185

(22) PCT Filed: Mar. 23, 2023
(86) PCT No.: PCT/IB2023/052885

§ 371 Date: Aug. 21, 2024

Related U.S. Application Data
(60) Provisional application No. 63/323,615, filed on Mar. 25, 2022.

(51) Int. Cl. A62C 35/10; A62C 3/16; B60L 3/00; B60L 50/64; H01M 50/204; H01M 50/249; H01M 50/258; H01M 50/682

(52) U.S. Cl. CPC A62C 35/10; A62C 3/16; B60L 3/0046; B60L 50/64; H01M 50/204; H01M 50/249; H01M 50/258; H01M 50/682; H01M 2220/20

(57) ABSTRACT

A battery pack comprising a housing defining a volume and a battery module arranged within the housing, where the battery module comprises a plurality of battery cells configured to provide an electrical output. The battery pack comprising a suppressant canister having a suppressant and positioned within the battery module proximate to the plurality of battery cells, where the suppressant canister is configured to provide the suppressant to the battery module to mitigate a thermal runaway.

### CROSS-REFERENCE TO RELATED PATENT APPLICATION

This application claims the benefit of and priority to U.S. Provisional Application No. 63/323,615, filed Mar. 25, 2022, the entire disclosure of which is incorporated by reference herein.

### BACKGROUND

The present disclosure relates generally to fire suppression systems. More specifically, the present disclosure relates to fire suppression systems for batteries. Modern battery technologies, such as lithium-ion batteries, are desirable for use in many energy storage applications due to their high energy density. However, the materials used in such batteries can be quite flammable and can produce flammable gases (e.g., when overheating). Once the batteries ignite, the resultant fires can be difficult to suppress due to their high temperatures, and the fires can travel quickly between adjacent battery cells. The cells of the batteries are often contained within a sealed housing, making it difficult for an external source of fire suppressant to reach the cells.

### SUMMARY

At least one embodiment relates to a battery pack. The battery pack includes a housing defining a volume, and a battery module arranged within the housing, where the battery module comprises a plurality of battery cells configured to provide an electrical output. The battery pack also includes a suppressant canister having a suppressant, positioned within the battery module proximate to the plurality of battery cells, where the suppressant canister is configured to provide the suppressant to the battery module to mitigate a thermal runaway.

In some embodiments, the plurality of battery cells are arranged in a matrix within the battery module, and wherein the suppressant canister is arranged within the matrix.

In some embodiments, the matrix includes the plurality of battery cells arranged in rows, and wherein the suppressant canister is arranged between a first battery cell and a second battery cell.

In some embodiments, the battery pack further includes another suppressant canister having another suppressant, where the suppressant canister is arranged between the first battery cell and the second battery cell in a first row, and the other suppressant canister is arranged between a third battery cell and a forth battery cell in a second row.

In some embodiments, in response to a failure of the battery pack the suppressant canister is configured provide the suppressant to a battery cell proximate to the suppressant canister.

In some embodiments, in response to a failure of the battery pack the suppressant canister is configured to uniformly provide the suppressant to the plurality of battery cells of the battery module.

In some embodiments, the suppressant canister includes a membrane configured to selectively seal the suppressant within the suppressant canister.

In some embodiments, in response to a failure of the battery pack the membrane is configured to degrade, and the suppressant canister is configured to provide the suppressant to a battery cell proximate the suppressant canister.

In some embodiments, the failure of the battery pack includes a change in temperature of the battery cell proximate the suppressant canister above a threshold.

Another embodiment relates to a vehicle comprising a chassis, a plurality of tractive elements coupled with the chassis, and a prime mover coupled with the plurality of tractive elements to propel the vehicle. The vehicle further comprises a battery pack coupled with the chassis, the battery pack configured to provide power to the prime mover. The battery pack comprises a housing defining a volume, and a battery module arranged within the housing, where the battery module comprises a plurality of battery cells configured to provide an electrical output. The battery pack further includes a suppressant canister having a suppressant and positioned within the battery module proximate to the plurality of battery cells, where the suppressant canister is configured to provide the suppressant to the battery module to mitigate a thermal runaway.

In some embodiments, the plurality of battery cells are arranged in a matrix within the battery module, and wherein the suppressant canister is arranged within the matrix.

In some embodiments, the matrix includes the plurality of battery cells arranged in rows, and wherein the suppressant canister is arranged between a first battery cell and a second battery cell.

In some embodiments, the vehicle further comprises another suppressant canister having another suppressant, where the suppressant canister is arranged between the first battery cell and the second battery cell in a first row, and the other suppressant canister is arranged between a third battery cell and a forth battery cell in a second row.

In some embodiments, in response to a failure of the battery pack the suppressant canister is configured provide the suppressant to a battery cell proximate to the suppressant canister.

In some embodiments, in response to a failure of the battery pack the suppressant canister is configured to uniformly provide the suppressant to the plurality of battery cells of the battery module.

In some embodiments, the suppressant canister includes a membrane configured to selectively seal the suppressant within the suppressant canister.

Another embodiment relates to a container system comprising a housing defining a volume, and a battery module arranged within the housing, where the battery module comprises a plurality of battery cells configured to provide an electrical output. The container system further comprises a suppressant canister having a suppressant and positioned within the housing, where the suppressant canister is configured to provide the suppressant to the battery module to mitigate a thermal runaway.

In some embodiments, the plurality of battery cells are arranged in a matrix within the battery module, and wherein the suppressant canister is arranged within the matrix.

In some embodiments, the plurality of battery cells are arranged in a matrix within the battery module, and wherein the suppressant canister is arranged between the matrix and a wall of the battery module.

In some embodiments, the container system further comprises a subpack arranged within the housing, wherein the battery module is arranged within the subpack and the suppressant canister is arranged within the subpack and coupled with an external wall of the battery module.

Another embodiment relates to a battery pack. The battery pack includes a housing defining a volume, and a plurality of battery modules arranged within the housing, where each of the plurality of battery modules comprises a plurality of battery cells configured to provide an electrical output. The battery pack also includes a suppressant canister having a suppressant and positioned within the housing, where the suppressant canister is configured to provide the suppressant to at least one battery module of the plurality of battery modules to mitigate a thermal runaway.

In some embodiments, the plurality of battery modules are arranged in a matrix within the housing, and where the suppressant canister is arranged within the matrix.

In some embodiments, the suppressant canister is positioned within the housing proximate to the at least one battery module, and where in response to a failure of the battery pack the suppressant canister is configured to provide the suppressant to the at least one battery module.

Another embodiment relates to a battery pack. The battery pack includes a housing defining a volume, and a plurality of subpacks arranged within the housing, each of the plurality of subpacks comprising a plurality of battery modules, each of the battery modules having a plurality of battery cells configured to provide an electrical output. The battery pack also including a suppressant canister having a suppressant and positioned within the housing, where the suppressant canister is configured to provide the suppressant to at least one subpack of the plurality of subpacks to mitigate a thermal runaway.

In some embodiments, the plurality of subpacks are arranged in a matrix within the housing, and wherein the suppressant canister is arranged within the matrix.

In some embodiments, the suppressant canister is positioned within the housing proximate to the at least one subpack, and where in response to a failure of the battery pack the suppressant canister is configured to provide the suppressant to the at least one subpack.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a schematic diagram of a battery system, according to an exemplary embodiment.

FIG. 2 is a block diagram of a control system for the battery system of FIG. 1, according to an exemplary embodiment.

FIG. 3 is a left side view of a vehicle utilizing the battery system of FIG. 1, according to an exemplary embodiment.

FIG. 4 is a perspective view of a containerized energy storage system including the battery system of FIG. 1, according to an exemplary embodiment.

FIG. 5 is a schematic diagram of the battery system of FIG. 1, according to another exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a battery pack configured to house and/or provide a first suppressant agent to components of the battery pack in order to prevent, eliminate, and/or mitigate a failure or thermal runaway event is shown, according to an exemplary embodiment. In an exemplary embodiment, the battery pack includes a housing defining a volume, and a battery module arranged within the housing, where the battery module comprises a plurality of battery cells configured to provide an electrical output. The battery pack also includes a suppressant canister having a suppressant, and positioned within the battery module proximate to the plurality of battery cells, where the suppressant canister is configured to provide the suppressant to the battery module to mitigate thermal runaway. In this regard, the battery pack described herein may include a suppressant canister positioned within the battery pack (e.g., the battery module), proximate to the plurality of battery cells, configured to provide targeted delivery of a suppressant.

In an exemplary embodiment, the battery pack described herein is configured to include suppressant canisters having firefighting suppressants and/or agents interspersed within a matrix of battery cells. Given that sources of hazard events (e.g., a failure or thermal runaway event) may be unknown and/or located in difficult to access locations (e.g., by external suppression systems), suppressant canisters may be implemented within the battery pack so as to provide a suppressant and/or agent source proximate to potential hazard event sources. In an exemplary embodiment, the battery pack includes suppressant canisters, within one or more battery modules, dispersed among battery cells. The suppressant canisters may discharge (e.g., deliver) suppressants housed in the canister to localized target areas proximate to the suppressant canisters. In this regard, the suppressant canisters may facilitate delivery of a suppressant to a local target area (e.g., a hazard event source proximate the suppressant canister), with or without an external suppression system (e.g., piping, etc.). In an exemplary embodiment, the one or more suppressant canisters are distributed within the battery pack, such that the suppressant canisters deliver (e.g., automatically) one or more suppressants to the battery pack as the hazard event spreads. In this regard, the configuration of the suppressant canisters may target, mitigate, and/or reduce potential losses of a hazard event.

### System Overview

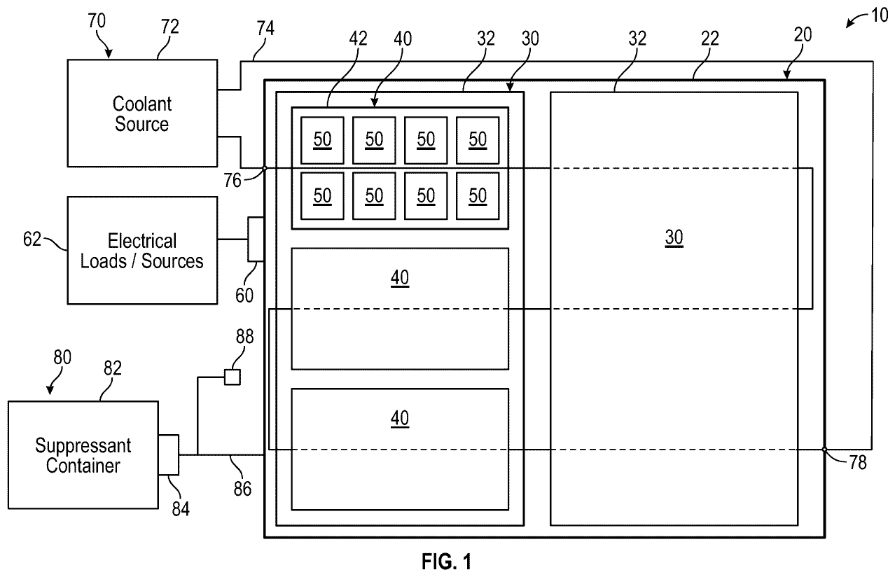

Referring to FIG. 1, a power system or battery system, shown as system 10, includes an energy storage device, energy storage assembly, battery assembly, power source, or electrical energy source, shown as battery pack 20, according to an exemplary embodiment. The battery pack 20 is configured to store energy (e.g., chemically) and later discharge the stored energy as electrical energy to power one or more electrical loads (e.g., electric motors, resistive elements, lights, speakers, etc.). In some embodiments, the battery pack 20 is rechargeable using electrical energy (e.g., from an electrical grid, from a fuel cell, from a solar panel, from an electrical motor being driven as a generator, etc.).

The battery pack 20 includes a shell or housing, shown as pack housing 22, that defines a volume containing components of the battery pack 20 (e.g., the subpacks 30). The pack housing 22 may seal the components of the battery pack 20 from the surrounding environment (e.g., limiting or preventing ingress of water or dust). The pack housing 22 may define one or more ports to facilitate transfer of electrical energy, coolant, fire suppressant, or other material into or out of the battery pack 20.

The battery pack 20 includes a series of battery portions or sections, shown as subpacks 30. By way of example, the battery pack 20 may include four subpacks 30. In other embodiments, the battery pack 20 includes more or fewer subpacks 30. Each subpack 30 is configured to store a portion of the stored energy of the battery pack 20. Each subpack 30 includes a housing 32 containing components of the subpack 30 (e.g., the battery modules 40).

Each subpack 30 includes a series of battery portions or sections, shown as battery modules 40. By way of example, each subpack 30 may include eight battery modules 40. In other embodiments, each subpack 30 includes more or fewer battery modules 40. Each battery module 40 is configured to store a portion of the stored energy of the corresponding subpack 30. Each battery module 40 includes a housing 42 containing components of the battery module 40 (e.g., the battery cells 50).

Each battery module 40 includes a series of battery portions or sections, shown as battery cells 50. By way of example, each battery module 40 may include hundreds of battery cells 50. In other embodiments, each battery module 40 includes more or fewer battery cells 50. Each battery cell 50 is configured to store a portion of the energy stored by the corresponding battery module 40.

In some embodiments, the battery cells 50 are lithium-ion (i.e., Li-ion) battery cells. Each battery cell 50 may be configured to receive electrical energy, store the received energy chemically, and release the stored electrical energy. As shown in FIG. 1, the battery cells 50 are arranged in rows adjacent one another within the battery module 40, reducing empty space within the battery module 40 and reducing the overall size of the battery pack 20. The battery cells 50 may be cylindrical cells, prismatic cells, pouch cells, or another form factor of battery cells.

The battery cells 50 may be electrically coupled to one another within the battery pack 20. By way of example, in one arrangement (a) the battery cells 50 within each battery module 40 are electrically coupled to one another, (b) the battery modules 40 within each subpack 30 are electrically coupled to one another, and (c) the subpacks 30 are electrically coupled to one another. The collective arrangement of battery cells 50, battery modules 40, and subpacks 30 is electrically coupled to a connector or port, shown as electrical port 60. The electrical port 60 electrically couples the battery cells 50 to one or more electrical sources and/or loads, shown as electrical loads/sources 62. The battery cells 50 may be discharged through the electrical port 60 to power the electrical loads/sources 62. The battery cells 50 may receive electrical energy through the electrical port 60 to charge the battery cells 50.

The battery cells 50, the battery modules 40, and the subpacks 30 may be arranged in series/parallel to control the output voltage of the battery pack 20 at the electrical port 60 and the capacity of the battery pack 20 at that output voltage. Battery cells 50 may be arranged in series with one another to increase an output voltage of the battery pack 20. Battery cells 50 may be arranged in parallel with one another to increase the capacity (e.g., measured in amp-hours) of the battery pack 20. By way of example, the battery modules 40 within each subpack 30 may be connected to one another in series, forming a string. The subpacks 30 may be connected to one another in parallel, such that the strings are connected in parallel.

In other embodiments, the battery pack 20 is otherwise arranged. By way of example, the battery pack 20 may include more or fewer battery cells 50, battery modules 40, and/or subpacks 30. By way of another example, the battery cells 50, battery modules 40, and/or subpacks 30 may be arranged in rows, columns, helical patterns, or otherwise positioned within the pack housing 22. In some embodiments, the subpacks 30 are omitted, and the battery modules 40 are positioned directly within the battery pack 20.

In some embodiments, the system 10 includes a cooling subsystem, shown as cooling system 70. The cooling system 70 includes a coolant source 72 that is configured to supply a flow of coolant to one or more conduits, shown as cooling channels 74. The coolant source 72 may include pumps, reservoirs, valves, and/or other components that facilitate handling the coolant. The coolant source 72 may also include one or more radiators or heat exchangers that facilitate discharging thermal energy from the coolant (e.g., to the surrounding atmosphere).

The cooling channels 74 pass into the pack housing 22 at an inlet 76 and exit the pack housing 22 at an outlet 78. The cooling channels 74 pass through the housings 32 of the subpacks 30 and the housings 42 of the battery modules 40 and pass adjacent (e.g., in contact with) the battery cells 50. In some embodiments, at least a portion of the cooling channels 74 is contained within and/or pass along the walls of the pack housing 22, the housings 32, and/or housings 42. The cooling channels 74 facilitate conduction between the coolant and the battery cells 50, such that thermal energy generated by the battery cells 50 (e.g., when charging or discharging electrical energy) is transferred to the coolant. The flow of coolant then transfers the thermal energy back to the coolant source 72 to be discharged. Accordingly, the cooling system 70 facilitates maintaining a consistent, low operating temperature of the battery pack 20.

Referring to FIG. 1, the system 10 further includes a fire suppression system, fire prevention system, or fire mitigation system, shown as suppression system 80. The suppression system 80 is configured to address fires within the battery pack 20 by supplying a fire suppressant. The suppressant may suppress active fires (e.g., preventing the fire from accessing oxygen). The suppressant may also cool the battery cells 50, preventing later ignition or reignition of the battery cells. The suppression system 80 may advantageously prevent, address, or otherwise mitigate thermal runaway of the battery cells 50.

The suppression system 80 includes a container of suppressant (e.g., a tank, a vessel, a cartridge, a reservoir, etc.) or fire suppressant source, shown as suppressant container 82. The suppressant may be held at an elevated pressure to facilitate dispensing the suppressant. The suppressant may include a gas (e.g., an inert gas, nitrogen, etc.), a liquid suppressant (e.g., water), a gel suppressant, a dry chemical suppressant, another type of suppressant, or combinations thereof.

The suppression system 80 further includes an actuator, shown as activator 84, that is configured to initiate a transfer (e.g., a flow) of fire suppressant from the suppressant container 82 to the battery pack 20. By way of example, the activator 84 may include a valve or seal puncture actuator that selectively permits suppressant to flow out of the suppressant container 82. By way of another example, the activator 84 may include a pump that is configured to impel the flow of suppressant.

The suppression system 80 further includes one or more conduits (e.g., pipes, hoses, tubes, etc.), shown as distribution network 86, that is configured to transfer suppressant from the suppressant container 82 to the battery pack 20. The distribution network 86 may transfer the suppressant to the interior of the battery pack 20 (e.g., inside the pack housing 22, inside the housing 32, inside the housing 42, etc.). Additionally or alternatively, the distribution network 86 may transfer the suppressant to the exterior of the battery pack 20. By way of example, the distribution network 86 may provide the suppressant to an outlet, shown as nozzle 88, that is positioned to direct suppressant to the exterior of the pack housing 22.

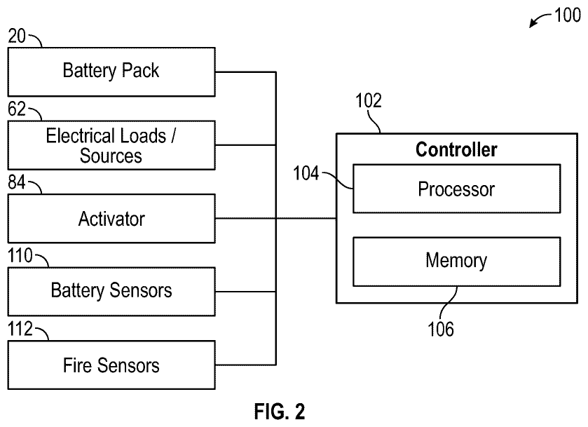

Referring to FIG. 2, a control system 100 of the system 10 is shown according to an exemplary embodiment. The control system 100 includes a processing circuit, shown as controller 102, including a processor 104 and a memory 106. The processor 104 may execute one or more instructions stored within the memory 106 to perform any of the functions described herein.

As shown, the controller 102 is operatively coupled to the battery pack 20, the electrical loads/sources 62, and the activator 84. The controller 102 may be configured to control operation of the battery pack 20 (e.g., as a battery management system), the electrical loads/sources 62, the suppression system 80, or any other component of the system 10. By way of example, the controller 102 may control charging and/or discharging of the battery pack 20. By way of another example, the controller 102 may control activation of the suppression system 80 to address one or more fires.

The control system 100 further includes one or more sensors, shown as battery sensors 110, operatively coupled to the controller 102. The battery sensors 110 may be configured to provide sensor data measuring one or more parameters related to the performance of the battery pack 20. By way of example, the battery sensors 110 may measure a current, voltage, and/or charge level within the battery pack 20. The battery sensors 110 may measure performance at the battery cell 50 level, the battery module 40 level, the subpack 30 level, and/or the battery pack 20 level. In some embodiments, the controller 102 is configured to use information from the battery sensors 110 to detect or predict a thermal event (e.g., a fire) associated with the battery pack 20. By way of example, the controller 102 may identify a change in measured current, voltage, or charge level that is indicative of a fire.

The control system 100 further includes one or more sensors, shown as thermal event sensors 112, configured to detect or predict a thermal event (e.g., a fire) associated with the battery pack 20. By way of example, the thermal event sensors 112 may include temperature sensors configured to detect an increase in temperature (e.g., of one of the battery cells 50) associated with a fire or a prediction of a fire. By way of another example, the thermal event sensors 112 may include an aspirating smoke detector that is configured to identify the presence of smoke or a gas that is produced (e.g., offgassed) when the battery cells 50 are above the standard operating temperature range. By way of another example, the thermal event sensors 112 may include an optical sensor that detects light produced by a fire.

In response to detection or prediction of a fire, the controller 102 may activate the suppression system 80 to address (e.g., prevent or suppress) the fire. By way of example, the controller 102 may actuate the activator 84 to direct suppressant to the battery pack 20. This suppressant may enter and/or surround the battery pack 20, addressing the fire.

Although a single controller 102 is shown in FIG. 2, it should be understood that the functionality of the controller 102 may be distributed across two or more separate controllers in communication with one another. By way of example, a first controller (e.g., a battery controller) may be dedicated for the battery management (e.g., controlling power usage from the battery cells 50 and charging of the battery cells 50). A second controller (e.g., a fire system controller) may be dedicated for management of the fire suppression system 80 (e.g., control over the activator 84 and the thermal event sensors 112). The two controllers would have the ability to communicate with each other such that when the fire system controller detects a fire, the fire system controller provides a signal to the battery controller. This signal commands the battery controller to disconnect or shut down usage of the affected batteries (e.g., battery packs 20, subpacks 30, battery modules 40, and/or battery cells 50) prior to discharging the fire suppression system 80.

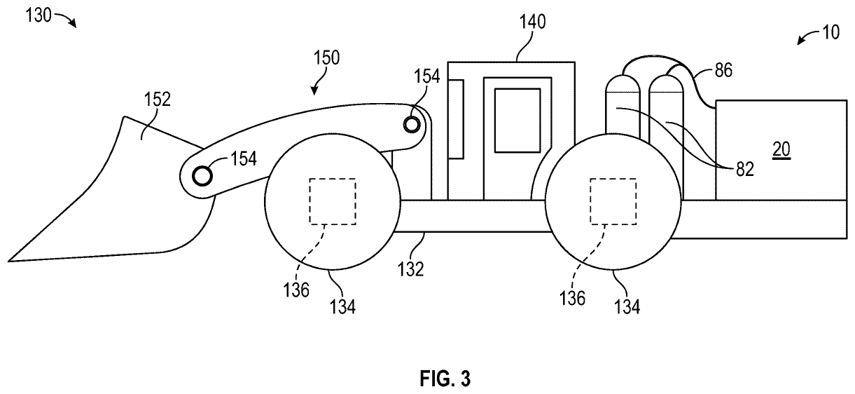

Referring to FIG. 3, a vehicle 130 is equipped with the battery system 10, according to an exemplary embodiment. As shown, the vehicle 130 is configured as a mining vehicle. Specifically, the vehicle 130 is configured as a front end loader. In other embodiments, the vehicle 130 is configured as another type of vehicle, such as a forestry vehicle, a passenger vehicle (e.g., a bus), a boat, or yet another type of vehicle.

The vehicle 130 includes a frame, shown as chassis 132, that is coupled to and supports a battery pack 20 and a pair of suppressant containers 82. The vehicle 130 includes a series of tractive elements (e.g., wheel and tire assemblies), shown as tractive elements 134, that are rotatably coupled to the chassis 132. The tractive elements 134 engage a support surface (e.g., the ground) to support the vehicle 130. The tractive elements 134 are coupled to a series of electric actuators or prime movers, shown as drive motors 136. The drive motors 136 are configured to drive the tractive elements 134 to propel the vehicle 130. In some embodiments, the drive motors 136 are electrically coupled to the battery pack 20. The drive motors 136 may consume electrical energy from the battery pack 20 (e.g., when propelling the vehicle 130) and/or provide electrical energy to charge the battery pack 20 (e.g., when performing regenerative braking).

The vehicle 130 further includes an operator compartment or cabin, shown as cab 140, that is coupled to the chassis 132. The cab 140 may be configured to contain one or more operators of the vehicle 130. The cab 140 may include one or more user interface elements (e.g., steering wheels, pedals, shifters, switches, knobs, dials, screens, indicators, etc.) that facilitate operation of the vehicle 130 by an operator.

The vehicle 130 further includes an implement assembly 150 coupled to the chassis 132. As shown, the implement assembly 150 includes an implement, shown as bucket 152. The implement assembly 150 further includes one or more actuators (e.g., electric motors, electric linear actuators, etc.), shown as implement actuators 154, that are configured to cause movement of the bucket 152 relative to the chassis 132. The implement actuators 154 may be electrically coupled to the battery pack 20. The implement actuators 154 may consume electrical energy from the battery pack 20 (e.g., when moving the bucket 152) and/or provide electrical energy to charge the battery pack 20 (e.g., when slowing the movement of the bucket 152).

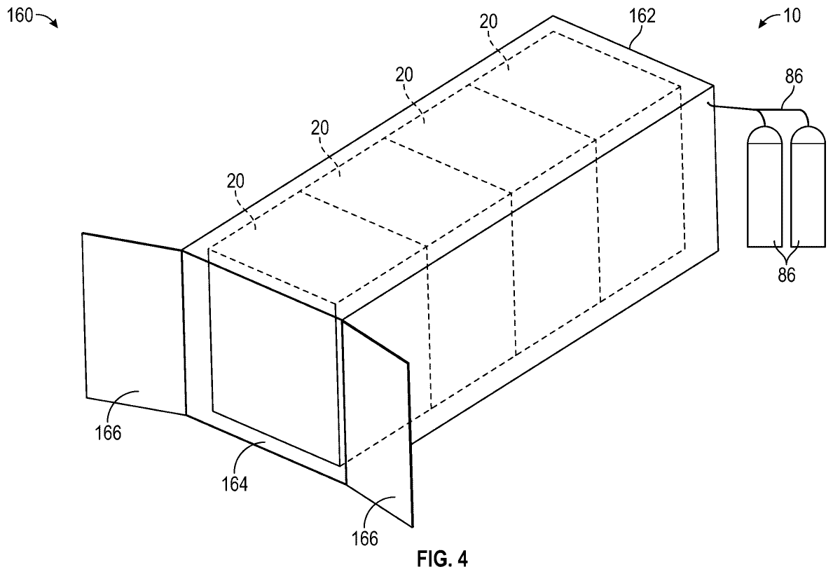

Referring to FIG. 4, a containerized energy storage system, shown as container system 160, is equipped with the battery system 10, according to an exemplary embodiment. In some embodiments, the container system 160 is configured to store energy to power one or more external electrical loads. The container system 160 may be portable (e.g., using a crane, using a container ship, using a semi truck, etc.).

As shown, the container system 160 includes a container, shown as shipping container 162, defining an internal volume 164. The internal volume 164 is selectively accessible from outside of the shipping container 162 through one or more doors 166. The internal volume 164 contains a series of battery packs 20 coupled to the shipping container 162. The battery packs 20 may be electrically coupled to one another, providing a large energy storage capacity.

### Battery Pack Having Suppressant Canister

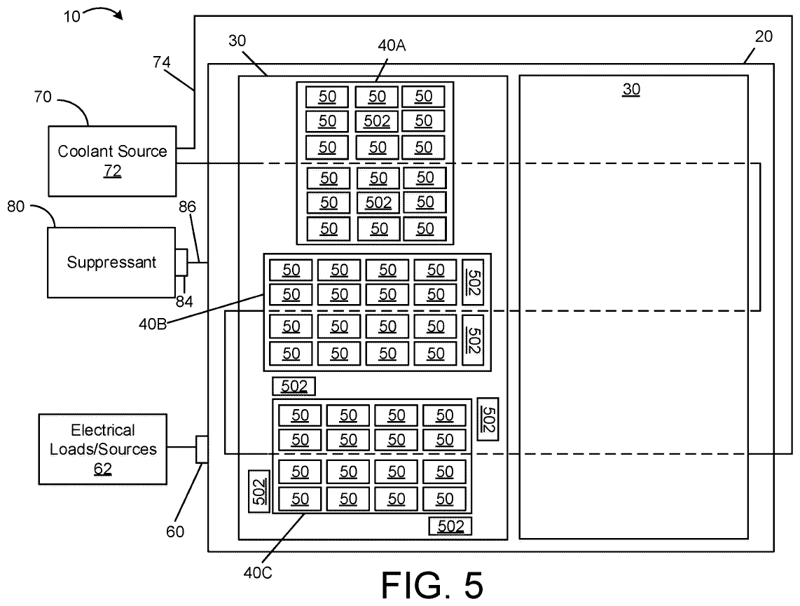

Referring now to FIG. 5, a power system or battery system is shown, according to an exemplary embodiment. In an exemplary embodiment, the power system or battery system is the system 10 of FIG. 1. The system is shown to include the battery pack 20 having the subpacks 30, battery modules 40, and battery cells 50. The system 10 may also include the cooling system 70, the suppression system 80, and/or the electrical port 60 to power the electrical loads/sources 62 (e.g., via components of the battery pack 20). The system 10 may also be used in combination with the control system 100 of FIG. 2, the vehicle 130 of FIG. 3, and/or the container system 160 of FIG. 4. According to an exemplary embodiment, the battery pack 20 includes one or more suppressant canisters having a suppressant. The suppressant canisters may be positioned within the battery pack 20, and may be configured to provide a fire suppressant or agent to components of the battery pack 20 in order to prevent, eliminate, and/or mitigate a failure or thermal runaway event.

As shown in FIG. 5, the battery pack 20 includes a series of subpacks 30 and a series of battery modules 40. As shown, the battery pack 20 includes two subpacks 30; however, in other embodiments the battery pack 20 includes any suitable number of subpacks 30 (e.g., 1, 4, 10, 15, 20, etc.). Further, each subpack 30 is shown to include three battery modules 40, shown as battery module 40A, battery module 40B, and battery module 40C. However, in other embodiments the subpack 30 includes any suitable number of battery modules 40 (e.g., 5, 8, 10, 20, 25, 50, etc.). In an exemplary embodiment, the battery modules 40 (e.g., battery modules 40A-40C) include a series of battery cells 50 and one or more suppressant canisters 502. As will be discussed below, the suppressant canister 502 may be configured to house a suppressant, and provide the suppressant to components of the battery pack 20 (e.g., the battery cells 50, the battery module 40, etc.) in order to target, prevent, eliminate, and/or mitigate a failure or thermal runaway event.

As shown in FIG. 5, the battery modules 40 (battery modules 40A-40C) include a plurality of battery cells 50. In an exemplary embodiment, the battery modules 40 are designed (e.g., size, shape, etc.) to reduce the empty space within the battery module 40 and/or the overall size of the battery pack 20, for example by complimenting the configurations of the components housed therein (e.g., battery cells 50, suppressant canisters 502, etc.). According to an exemplary embodiment, the battery modules 40 include a number of battery cells 50 arranged in a matrix, so as to reduce the empty space within the battery module 40. For example, the battery cells 50 (e.g., 10, 50, 100, 250, etc.) may be arranged in a matrix having rows (e.g., 5, 10, 25, 50, etc.) that are adjacent to one another. In other embodiments, the battery cells 50 are arranged in a matrix having another suitable pattern and/or configuration (e.g., concentric rings, circles, squares, stacked, layered, etc.). In an exemplary embodiment, the battery cells 50 are lithium-ion (i.e., Li-ion) battery cells, which may be cylindrical cells, prismatic cells, pouch cells, or another form factor of battery cells. However, in other embodiments, the battery cells 50 are other suitable battery cells.

As shown in FIG. 5, the battery modules 40 may include one or more suppressant canisters 502. In an exemplary embodiment, the suppressant canister 502 (e.g., a cell, cartridge, membrane, vessel, reservoir, tank, etc.) is configured to house and/or provide a suppressant or agent, so as to address a failure or thermal runaway event within the battery pack 20. For example, the suppressant canister 502 may be configured to cool the battery cells 50 (e.g., to prevent later ignition, re-ignition, etc.), suppress an active fire (e.g., prevent a fire from accessing oxygen), and/or prevent, address, or otherwise mitigate thermal runaway of the battery cells 50. The suppressant canister 502 may also selectively house a suppressant or agent, for example a liquid suppressant (e.g., water), a gas (e.g., an inert gas, nitrogen, etc.), a gel suppressant, a dry chemical suppressant, another type of suppressant or agent, and/or any combination thereof. In some embodiments, the suppressant canister 502 is configured to generate and/or house nitrogen, which may be provided to one or more components of the battery pack 20 (e.g., the battery cells 50, battery module 40, etc.). For example, the suppressant canister 502 may house a plurality of chemicals (e.g., two), which may mix in response to a failure or thermal runaway event (e.g., elevated temperature, pressure, etc.). The chemical mixture may generate nitrogen, which may be housed in the suppressant canister 502 and/or provided to the battery pack 20.

According to an exemplary embodiment, the suppressant canisters 502 are configured to be dispersed within a matrix of battery cells 50 within the battery module 40. In this regard, the suppressant canister 502 may be a cylindrical cell, prismatic cell, pouch cell, and/or any other similar or suitable form factor (e.g., shape, size, configuration, etc.) relative to adjacent battery cells 50. The suppressant canisters 502 may be of form factor and/or interspersed within a matrix of battery cells 50, so as to reduce the empty space within the battery module 40. According to an exemplary embodiment, the suppressant canisters 502 also include a detector configured to detect a failure or thermal runaway event, and/or an actuator configured to initiate delivery of the suppressant to a target area. For example, the suppressant canisters 502 may include a membrane lining that acts as a detector and/or an actuator. In response to a failure or thermal runaway event (e.g., temperature increase, pressure increase, gas or electrolyte leak, etc.), the membrane lining may be configured to degrade, so as to facilitate delivery of the suppressant from the suppressant canister 502 to the target area. In some embodiments, the suppressant canisters 502 include other detection, activation, and/or distribution components, for example a valve, seal, switch, sensor, nozzle, pump, etc. configured to detect, activate, and/or deliver a suppressant to a target area. In this regard, the suppressant canisters 502 (and/or components thereof) may be configured to act as a self-contained suppression system, dispersed within a matrix of battery cells 50 (e.g., within the battery module 40), so as to target, prevent, eliminate, and/or mitigate a failure or thermal runaway event. In other embodiments, the suppressant canisters 502 are communicably connected to an external system or device (e.g., the controller 102, the suppression system 80, etc.), such that the suppressant canisters 502 are configured to deliver the suppressant in accordance with an external communication and/or protocol.

As shown in FIG. 5, the suppressant canisters 502 may be positioned within the battery module 40 and/or nested within a matrix of battery cells 50. In an exemplary embodiment, the suppressant canisters 502 are distributed throughout the battery module 40 adjacent to the battery cells 50 (e.g., within the matrix of battery cells 50). The distribution of the suppressant canisters 502 may be configured to facilitate timely delivery of a suppressant to a target area (e.g., via proximity, suppressant type, delivery method, etc.), for example in response to a failure or thermal runaway event. For example, the battery module 40A of FIG. 5 is shown to include two suppressant canisters 502 arranged at centers of two groups of battery cells 50, respectively (e.g., a suppressant canister 502 surrounded by eight battery cells 50). In this regard, battery module 40A shows that the suppressant canisters 502 may be uniformly dispersed within the matrix of battery cells 50 (e.g., the battery module 40A); however, in some embodiments the suppressant canisters 502 are clustered at a first portion of the battery module 40A (e.g., a central portion, etc.) and/or dispersed at a second portion (e.g., a perimeter portion, etc.). In other embodiments, the suppressant canisters 502 are arranged in a configuration or pattern within the battery module 40A (e.g., around a perimeter, in concentric squares, rectangles, circles, etc., horizontal snaking rows, vertical snaking columns, etc.). In other embodiments, the suppressant canisters 502 are grouped at a portion of the battery module 40A (e.g., a first corner, a second corner, opposite corners, a top or bottom wall, a side wall, etc.), and/or absent from another portion of the battery module 40A (e.g., adjacent a cooling channel, etc.). It should be understood that while the suppressant canisters 502 are described herein as being distributed in certain configurations within a matrix of battery cells 50 (e.g., battery module 40), it is contemplated that the suppressant canisters 502 may be in any suitable pattern, configuration, or otherwise within a battery module 40 so as to facilitate timely delivery of a suppressant to a target area or areas.

According to an exemplary embodiment, the suppressant canisters 502 are also of varying sizes and configurations, house varying suppressants (e.g., liquid, gas, gel, dry chemical, etc.), and/or include different working components (e.g., a valve, seal, switch, nozzle, pump, etc.). For example, the battery module 40A of FIG. 5 is shown to include two suppressant canisters 502 at central portions of two groups of battery cells 50, respectively, within a matrix. One suppressant canister 502 may, for example, house a liquid (e.g., water, liquid carbon dioxide, etc.), and may be configured to dispense (e.g., via a value, nozzle, etc.) the liquid within the battery module 40A, in a center-out pattern, in response to a failure or thermal runaway event. The other suppressant canisters 502 may, for example, house a gas (an inert gas, nitrogen, etc.), and may be configured to dispense (e.g., slow release, quick shot, pulsed release, etc.) the gas to the battery module 40A in response to the failure or thermal runaway event. In other embodiments, the suppressant canisters 502 are otherwise distributed and/or configured, such that the plurality of suppressant canisters 502 are configured to facilitate timely delivery of one or more suppressants to a target area, in order to target, prevent, eliminate, and/or mitigate a failure or thermal runaway event.

As shown in FIG. 5, in some embodiments the suppressant canisters 502 are positioned within the battery module 40 and/or nested along a matrix of battery cells 50. In an exemplary embodiment, the suppressant canisters 502 are selectively distributed throughout the battery module 40 adjacent to the battery cells 50, and/or are dispersed along a matrix of battery cells 50 so as to reduce the empty space within the battery module 40. For example, the battery module 40B of FIG. 5 is shown to include suppressant canisters 502 arranged between a matrix of battery cells 50 and an end portion of the battery module 40B (e.g., an end wall). The battery module 40B may also include suppressant canisters 502 arranged between a matrix of battery cells 50 and another portion of the battery module 40B (e.g., a first end, a top wall, a bottom wall, a first corner, a second corner, etc.). In some embodiments, the suppressant canisters 502 are arranged in configurations and/or patterns between matrices of battery cells 50, for example in rows sandwiched between rows of the battery cells 50 (e.g., alternating the cooling channel 74, etc.), etc. In other embodiments, the suppressant canisters 502 are positioned in another suitable pattern, configuration, or otherwise within a battery module 40, so as reduce the empty space within the battery module 40 and/or facilitate timely delivery of a suppressant to a target area or areas.

As shown in FIG. 5, in other embodiments the suppressant canisters 502 are positioned within and/or adjacent to other components of the battery pack 20. For example, as shown in FIG. 5, the suppressant canisters 502 may be positioned within the subpack 30, adjacent to the battery module 40C (and the battery cells 50 contained therein). The suppressant canisters 502 may be distributed through the subpack 30 adjacent to the battery modules 40 (and/or battery cells 50 therein), and may be configured to facilitate timely delivery of a suppressant to a target area or areas (e.g., the battery module 40C, within the subpack 30, etc.). The battery module 40C of FIG. 5 is shown to include suppressant canisters 502 arranged around an exterior perimeter of the battery module 40C (e.g., at corners); however, in other embodiments the suppressant canisters 502 are positioned in another suitable pattern, configuration, or otherwise within the subpack 30. In some embodiments, the battery module 40C includes one or more apertures at an exterior portion of the battery module 40C (e.g., exterior wall). The one or more apertures may facilitate delivery of a suppressant to an interior portion of the battery module 40C. In this regard, the suppressant canisters 502 positioned at the exterior of the battery module 40C may be configured to deliver a suppressant to battery cells 50 within the battery module 40C, as well as the interior volume of the subpack 30. It should be understood that while the suppressant canisters 502 are described herein as being distributed within a matrix of battery cells 50 within the battery modules 40, it is contemplated that the suppressant canisters 502 may be distributed in any arrangement, pattern, configuration, or otherwise within, or adjacent to, the battery pack 20 in order to target, prevent, eliminate, and/or mitigate a failure or thermal runaway event (e.g., between or within a matrix of batter modules 40, the subpacks 30, etc.).

As an illustrative example, the components of FIGS. 1-5 may be used to address, and/or mitigate a failure or a runaway event of the battery pack 20. According to an exemplary embodiment, the battery pack 20 includes the battery modules 40 (e.g., the battery module 40A, battery module 40B, battery module 40C), battery cells 50, and/or suppressant canisters 502 shown in FIG. 5. The battery pack 20 may also be in communication with the cooling system 70, which may be configured to facilitate maintaining a consistent, low operating temperature of the battery pack 20. However, in some instances the cooling system 70 is unable to maintain a consistent and/or low operating temperature of the battery pack 20.

In some circumstances, components of the battery pack 20 may begin to operate at elevated current levels, temperatures, pressures, and/or other characteristics indicative of a failure or thermal runaway event. For example, a battery cell 50 of the battery module 40A may begin to operate at an elevated current level, resulting in an elevated temperature and/or pressure in an area proximate to the battery cell 50. A suppressant canister 502 of the battery module 40A (e.g., proximate the battery cell 50) may be configured to identify the change (e.g., via a change in membrane formation, via a sensor, etc.). Further, in response to an identified local change (e.g., above a threshold, a deviation threshold), the suppressant canister 502 may configured to deliver the suppressant to the battery cell 50, for example via degradation of a canister membrane, actuation of a nozzle or valve, etc. In some embodiments, the change is sufficient to cause a plurality of suppressant canisters 502 to deliver one or more suppressants to the battery cell 50, as discussed above. In this regard, the suppressant canisters 502 of the battery module 40A may be configured to deliver one or more suppressants (e.g., gas, liquid, etc.) to a battery cell 50, so as to prevent, eliminate, and/or mitigate the identified failure or thermal runaway event.

In other circumstances, one or more battery cells 50 (e.g., of the battery module 40B) may begin to operate at an elevated current level, resulting in an elevated temperature and/or the production of gas and/or smoke in the battery module 40B. A suppressant canister 502 of the battery module 40B may be configured to identify the change (e.g., via a change in membrane formation, via a sensor, etc.), and/or deliver a suppressant to the battery module 40B (e.g., via degradation of the membrane, via a nozzle, valve, etc.). For example, in response to an identified change, a suppressant canister 502 may be configured to deliver a gas suppressant (e.g., inert gas, nitrogen, etc.) uniformly to the battery cells 50 of the battery module 40B. In some embodiments, the change is sufficient to cause a plurality of suppressant canisters 502 to deliver one or more suppressants to the battery module 40B. For example, a first suppressant canister 502 may be configured to quick-release deliver a first suppressant (e.g., an inert gas, nitrogen, etc.), and a second suppressant canister 502 may slow-release deliver a second suppressant (e.g., an inert gas, nitrogen, etc.). In this regard, the suppressant canisters 502 of the battery module 40B may be configured to deliver one or more suppressants (e.g., gas, liquid, etc.) to battery cells 50 throughout the battery module 40B, so as to prevent, eliminate, and/or mitigate the identified failure or thermal runaway event.

In yet other circumstances, one or more battery cells 50 (e.g., of the battery module 40C) may begin to operate at an elevated current level, resulting in a cascaded elevation in temperature, pressure, and/or smoke. A suppressant canister 502 positioned at an exterior of the battery module 40C may be configured to identify the change (e.g., via a change in membrane formation, via a sensor, etc.), and/or deliver a suppressant to an exterior of the battery module 40C (e.g., via membrane degradation, via a nozzle, valve, etc.). For example, in response to an identified change, a suppressant canister 502 may deliver a liquid suppressant (e.g., water, liquid nitrogen, etc.) to an exterior of the battery module 40C. The liquid suppressant may be delivered to an interior of the battery module 40C (e.g., via one or more apertures) and/or around the battery module 40C within the subpack 30. In some embodiments, the cascade is sufficient to cause a plurality of suppressant canisters 502 (e.g., positioned around an exterior of the battery module 40C) to deliver one or more suppressants to the battery module 40C. For example, a first suppressant canister 502 may quick-release deliver a first suppressant (e.g. inert gas, nitrogen, etc.) to an interior/exterior of the battery module 40C at a first location, and a second suppressant canister 502 my deliver a second suppressant (e.g., water, liquid nitrogen, etc.) to an interior/exterior of the battery module 40C at a second location. In this regard, the suppressant canisters 502 positioned at the exterior of the battery module 40C may be configured to deliver one or more suppressants (e.g., gas, liquid, etc.) to the battery module 40C (and/or battery cells 50 therein), so as to prevent, eliminate, and/or mitigate the identified failure or thermal runaway event.

### Configuration of the Exemplary Embodiments

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system 10 as shown in the various exemplary embodiments is illustrative only. Additionally, any element disclosed in one embodiment may be incorporated or utilized with any other embodiment disclosed herein. For example, the arrangement of multiple battery packs 20 of the exemplary embodiment shown in at least FIG. 4 may be incorporated in the vehicle 130 of the exemplary embodiment shown in at least FIG. 3. Although only one example of an element from one embodiment that can be incorporated or utilized in another embodiment has been described above, it should be appreciated that other elements of the various embodiments may be incorporated or utilized with any of the other embodiments disclosed herein.

1. A battery pack, comprising:
a housing defining a volume;
a battery module arranged within the housing, wherein the battery module comprises a plurality of battery cells configured to provide an electrical output; and
a suppressant canister having a suppressant and positioned within the battery module proximate to the plurality of battery cells, wherein the suppressant canister is configured to provide the suppressant to the battery module to mitigate a thermal runaway.

2. The battery pack of claim 1, wherein the plurality of battery cells are arranged in a matrix within the battery module, and wherein the suppressant canister is arranged within the matrix.

3. The battery pack of claim 2, wherein the matrix includes the plurality of battery cells arranged in rows, and wherein the suppressant canister is arranged between a first battery cell and a second battery cell.

4. The battery pack of claim 3, further comprising another suppressant canister having another suppressant, wherein the suppressant canister is arranged between the first battery cell and the second battery cell in a first row, and the other suppressant canister is arranged between a third battery cell and a forth battery cell in a second row.

5. The battery pack of claim 1, wherein in response to a failure of the battery pack the suppressant canister is configured provide the suppressant to a battery cell proximate to the suppressant canister.

6. The battery pack of claim 1, wherein in response to a failure of the battery pack the suppressant canister is configured to uniformly provide the suppressant to the plurality of battery cells of the battery module.

7. The battery pack of claim 1, wherein the suppressant canister includes a membrane configured to selectively seal the suppressant within the suppressant canister.

8. The battery pack of claim 7, wherein in response to a failure of the battery pack the membrane is configured to degrade, and the suppressant canister is configured to provide the suppressant to a battery cell proximate the suppressant canister.

9. The battery pack of claim 8, wherein the failure of the battery pack includes a change in temperature of the battery cell proximate the suppressant canister above a threshold.

10. A vehicle comprising:
a chassis;
a plurality of tractive elements coupled with the chassis;
a prime mover coupled with the plurality of tractive elements, the prime mover configured to drive the plurality of tractive elements to propel the vehicle; and
a battery pack coupled with the chassis, the battery pack configured to provide power to the prime mover, the battery pack comprising:
a housing defining a volume;
a battery module arranged within the housing, wherein the battery module comprises a plurality of battery cells configured to provide an electrical output; and
a suppressant canister having a suppressant and positioned within the battery module proximate to the plurality of battery cells, wherein the suppressant canister is configured to provide the suppressant to the battery module to mitigate a thermal runaway.

11. The vehicle of claim 10, wherein the plurality of battery cells are arranged in a matrix within the battery module, and wherein the suppressant canister is arranged within the matrix.

12. The vehicle of claim 11, wherein the matrix includes the plurality of battery cells arranged in rows, and wherein the suppressant canister is arranged between a first battery cell and a second battery cell.

13. The vehicle of claim 12, further comprising another suppressant canister having another suppressant, wherein the suppressant canister is arranged between the first battery cell and the second battery cell in a first row, and the other suppressant canister is arranged between a third battery cell and a forth battery cell in a second row.

14. The vehicle of claim 10, wherein in response to a failure of the battery pack the suppressant canister is configured provide the suppressant to a battery cell proximate to the suppressant canister.

15. The vehicle of claim 10, wherein in response to a failure of the battery pack the suppressant canister is configured to uniformly provide the suppressant to the plurality of battery cells of the battery module.

16. The vehicle of claim 10, wherein the suppressant canister includes a membrane configured to selectively seal the suppressant within the suppressant canister.

17. A container system, comprising:
a housing defining a volume;
a battery module arranged within the housing, wherein the battery module comprises a plurality of battery cells configured to provide an electrical output; and
a suppressant canister having a suppressant and positioned within the housing, wherein the suppressant canister is configured to provide the suppressant to the battery module to mitigate a thermal runaway.

18. (canceled)

19. (canceled)

20. The container system of claim 17, further comprising a subpack arranged within the housing, wherein the battery module is arranged within the subpack and the suppressant canister is arranged within the subpack and coupled with an external wall of the battery module.

21. The battery pack of claim 1, comprising:
the battery module is a first battery module of a plurality of battery modules.

22. (canceled)

23. (canceled)

24. The battery pack of claim 1, comprising:
a housing defining a volume;
a plurality of subpacks arranged within the housing, wherein the battery module is a first battery module of a plurality of battery modules, wherein each of the plurality of subpacks comprises multiple battery modules of the plurality of battery modules, each of the battery modules having multiple battery cells of the plurality of battery cells.

25. (canceled)

26. (canceled)
